(19) United States
(12) Patent Application Publication
(10) Pub. No.: US 2013/0036842 A1
(43) Pub. Date: Feb. 14, 2013

(54) MONITORING METHOD FOR TESTING APPARATUS

(71) Applicant: Dong CHEN, Shenzhen City (CN)

(72) Inventor: Dong CHEN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/478,269

(22) Filed: May 23, 2012

(30) Foreign Application Priority Data
Aug. 10, 2011 (CN) 201110228071.3

(51) Int. Cl. G01D 7/00

(52) U.S. Cl. 73/866.3

(57) ABSTRACT

A monitoring method includes following steps: placing a tested product in each of a plurality of testing locations of a testing apparatus; turning on the testing apparatus, collecting location information of the plurality of testing locations by a testing information collection module of the testing apparatus; transmitting the location information to a displaying control module; displaying a plurality of indicating blocks on a displaying apparatus by the displaying control module according to the location information; collecting testing state information of the testing product by the testing information collection module, and transmitting the testing state information to the displaying control module; and controlling a corresponding one of the plurality of indicating blocks to indicate a corresponding testing state by the displaying control module.

### TECHNICAL FIELD

The present disclosure relates to monitoring methods, and particularly to a monitoring method for monitoring a testing apparatus.

### DESCRIPTION OF RELATED ART

In one testing process, the electronic devices are tested one by one, which is inefficient and time-consuming. In another testing process, a testing apparatus is used to test a plurality of electronic devices simultaneously. However, because these electronic devices are different, when some electronic devices have completed testing, some electronic devices are still being tested. Thus, the testing process of these electronic devices needs to be monitored.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of a monitoring system for utilizing a monitoring method of an embodiment.

FIG. 2 is a block view of the testing apparatus and a monitoring apparatus of the monitoring system of FIG. 1.

FIG. 3 is a flow chart of a monitoring method of an embodiment.

FIG. 4 is a detailed flow chart of sub steps of the step S306 of FIG. 3.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

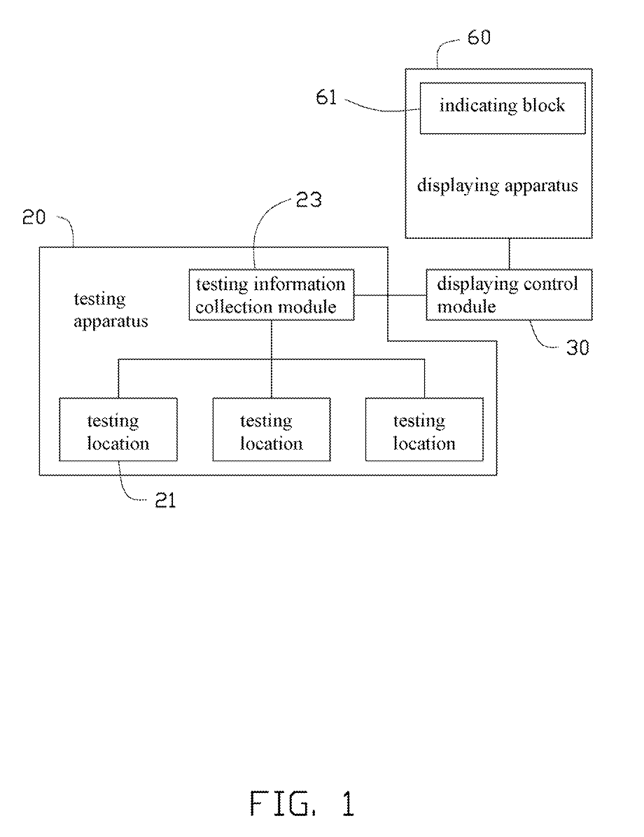

Referring to FIG. 1, an embodiment of a monitoring method is used to monitor a plurality of test products which are tested by the testing apparatus 20. The testing apparatus 20 includes a plurality of testing locations 21. Each of the plurality of testing locations 21 receives a test product which is tested by the testing apparatus 20. The testing apparatus 20 further includes a testing information collection module 23 which is connected to the plurality of testing locations 21. The testing information collection module 23 collects testing state information of the tested products and location information of the plurality of testing locations 21. The testing state information includes four states which are pre-tested state, under-tested state, test-completed state, and test-failed state.

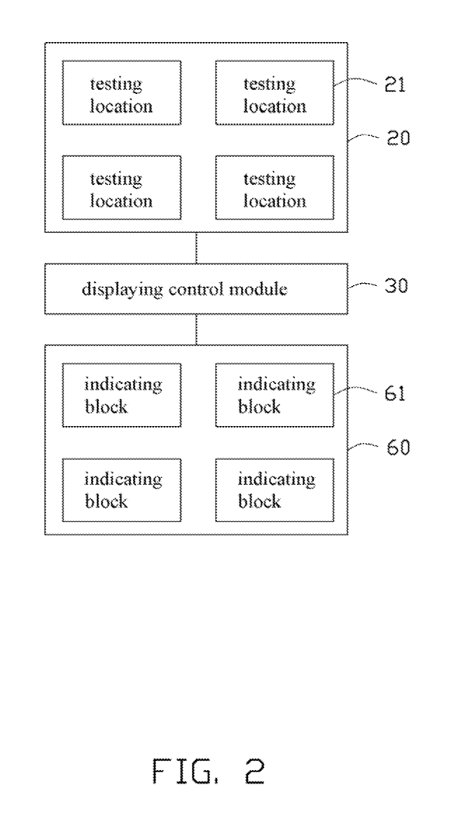

Referring to FIGS. 1 and 2, a displaying control module 30 is connected to the testing information collection module 23. The testing state information of each tested product and the location information of the plurality of testing locations 21 are transmitted to the displaying control module 30 by the testing information collection module 23.

A displaying apparatus 60 is connected to the displaying control module 30. The displaying control module 30 controls the displaying apparatus 60 to display a plurality of indicating blocks 61 thereon corresponding to the plurality of testing locations 21 of the testing apparatus 20 according to the location information of the plurality of testing locations 21. The plurality of indicating blocks 61 are located on the displaying apparatus 60 in a manner as that the testing locations 21 on the testing apparatus 20. For example, in one embodiment, the testing apparatus 20 includes four of the testing locations 21. The four testing locations 21 are located in a manner of two rows and two lines. The displaying apparatus 60 correspondingly displays four of the indicating blocks 61 which are also displayed in the manner of two rows and two lines. An indicating block 61 indicates one of the testing locations 21 which has a similar position as that of the indicating block 61. For example, the indicating block 61 which is located on the first row and the first line on the displaying apparatus 60 is used to indicate a testing state of the corresponding tested product located in the testing location 21 which is located on first row and the first line on the testing apparatus 20. The indicating block 61 which is located on the first row of the second line on the displaying apparatus 70 corresponds to the testing location 21 which is located on first row of the second line on the testing apparatus 20. Analogously, the indicating block 61 which is located on the second row of the second line on the displaying apparatus 70 corresponds to the testing location 21 which is located on second row of the second line on the testing apparatus 20.

The testing information collection module 23 numbers the testing locations 21. For example, the testing location 21 which is located on the first row of the first line is numbered as “1”, the testing location 21 which is located on the first row of the second line is numbered as “2”, the testing location 21 which is located on the second row of the first line is numbered as “3”, and the testing location 21 which is located on the second row of the second line is numbered as “4”.

The displaying control module 30 controls the indicating block 61 to indicate different colors or symbols corresponding to different testing states of the corresponding tested product. For example, when the tested product is in the pre-tested state, corresponding one of the plurality of indicating blocks 61 shows blue color. When the tested product is in the under-tested state, the corresponding one of the plurality of indicating blocks 61 shows yellow color. When the tested product is in the completed-tested state, the corresponding one of the plurality of indicating blocks 61 shows green color. When the tested product is in the test-failed state, the corresponding one of the plurality of indicating blocks 61 shows red color.

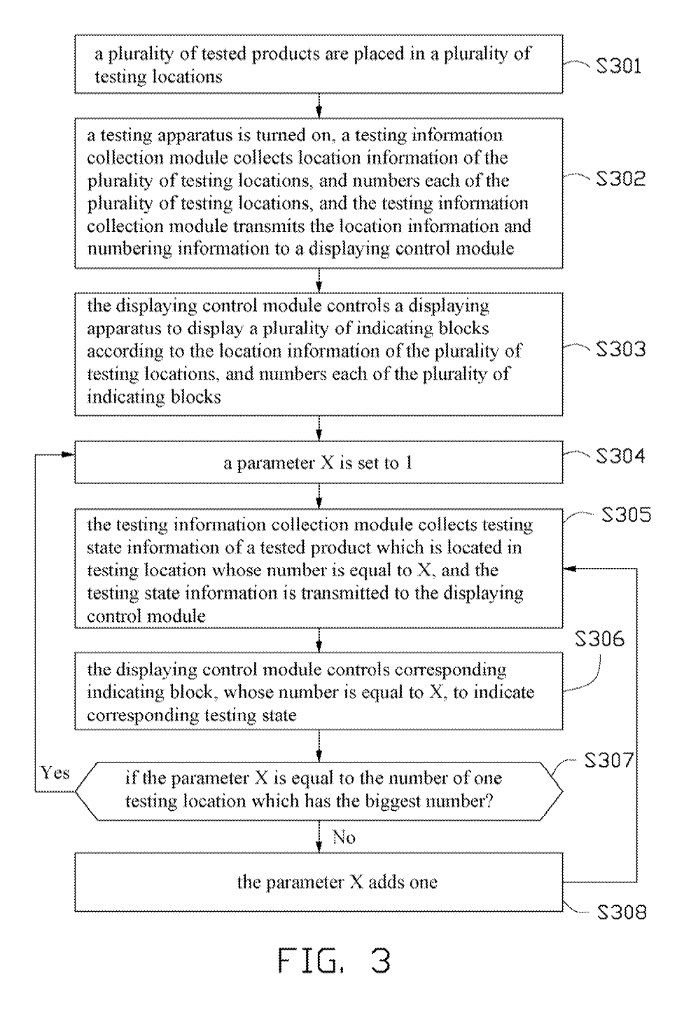

Referring to FIG. 3, an embodiment of a monitoring method is shown as follows.

In step S301, a plurality of tested products are placed in a plurality of testing locations 21.

In step S302, the testing apparatus 20 is turned on. The testing information collection module 23 collects location information of the plurality of testing locations 21, and numbers each of the plurality of testing locations 21. The testing information collection module 23 transmit the location information and numbering information to the displaying control module 30.

In step S303, the displaying control module 30 controls the displaying apparatus 60 to display a plurality of indicating blocks 61 thereon according to the location information of the plurality of testing locations 21, and numbers each of the plurality of indicating blocks 61.

In step S304, a parameter X is set to 1.

In step S305, the testing information collection module 23 collects testing state information of a test product which is located in the testing location whose number is equal to X, and the testing state information is transmitted to the displaying control module 30.

In step S306, the displaying control module 30 controls corresponding indicating block, whose number is equal to X, to indicate corresponding testing state.

In step S307, check if the parameter X is equal to the number of one testing location which has the biggest number; if yes, go to step S304, and if not, go to step S308.

In step S308, the parameter X adds one, then go to step S305.

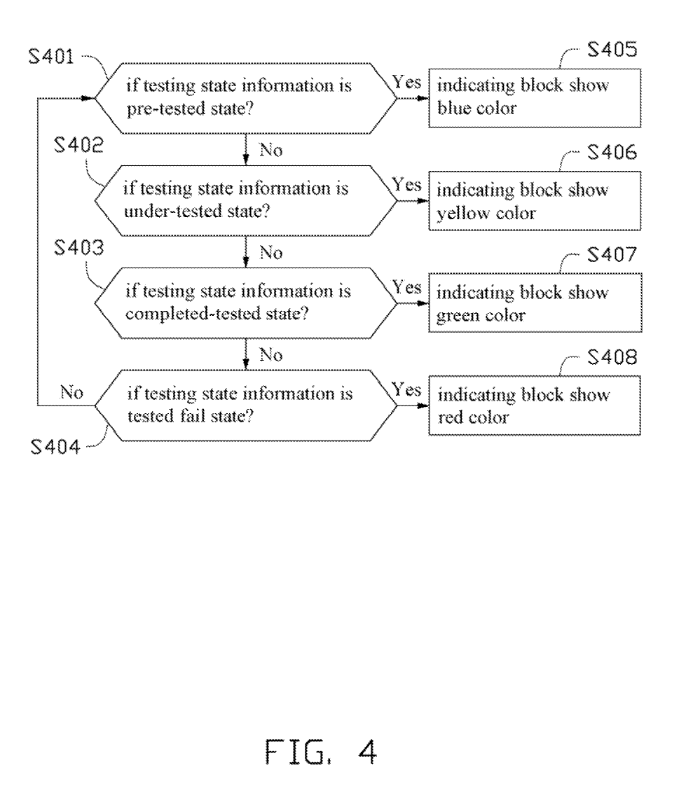

Referring to FIG. 4, detailed steps of the step S306 is shown as follows.

In step S401, the displaying control module 30 checks if the testing state information is pre-tested state; if yes, go to step S405, and if no, go to step S402.

In step S402, the displaying control module 30 checks if the testing state information is under-tested state; if yes, go to step S406, and if no, go to step S403.

In step S403, the displaying control module 30 checks if the testing state information is test-completed state; if yes, go to step S407, and if no, go to step S404.

In step S404, the displaying control module 30 checks if the testing state information is test-failed state; if yes, go to step S408, and if no, go to step S401.

In step S405, corresponding indicating block show blue color.

In step S406, corresponding indicating block show yellow color.

In step S407, corresponding indicating block show green color.

In step S408, corresponding indicating block show red color.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the invention to the full extent indicated by the broad general meaning of the terms in which the appended claims are expressed.

What is claimed is:

1. A monitoring method, comprising:
placing a tested product in each of a plurality of testing locations of a testing apparatus;
turning on the testing apparatus, collecting location information of the plurality of testing locations by a testing information collection module of the testing apparatus;
transmitting the location information to a displaying control module;
displaying a plurality of indicating blocks on a displaying apparatus by the displaying control module according to the location information;
collecting testing state information of the testing product by the testing information collection module, and transmitting the testing state information to the displaying control module; and
controlling a corresponding one of the plurality of indicating blocks to indicate a corresponding testing state by the displaying control module.

2. The monitoring method of claim 1, comprising numbering each of the plurality of testing locations according to the location information by the testing information collection module.

3. The monitoring method of claim 2, further comprising numbering each of the plurality of indicating blocks by the displaying control module, and a number of a first indicating block of the plurality of indicating blocks and a number of a first testing location of the plurality of testing locations are same, a relative location of the first testing location relative to the plurality of the testing locations is same as a relative location of the first indicating block relative to the plurality of indicating blocks.

4. The monitoring method of claim 1, wherein the testing state information comprises states of pre-tested, states of under-tested, states of completed-tested, and states of test-failed.

5. The monitoring method of claim 1, comprising displaying the plurality of indicating blocks with different colors to indicate different testing states.

6. The monitoring method of claim 1, comprising displaying the plurality of indicating blocks on the displaying apparatus in an arrangement same as an arrangement of the plurality of testing locations on the testing apparatus.

7. The monitoring method of claim 6, wherein an indicating block of the plurality of indicating blocks is adapted to indicate testing states of the tested product in a testing location of the plurality of testing locations, a relative location of the testing location relative to the testing apparatus is same as a relative location of the indicating block relative to the display apparatus.

8. A monitoring method, comprising steps in an order as follows:
placing a tested product in each of a plurality of testing locations;
collecting location information of the plurality of testing locations by a testing information collection module;
transmitting the location information to a displaying control module by the testing information collection module;
displaying a plurality of indicating blocks on a displaying apparatus, the displaying apparatus being controlled by the displaying control module;
collecting testing state information of the testing product, and transmitting the testing state information to the displaying control module by the testing information collection module; and
indicating a testing state corresponding to the testing information on each of the plurality of indicating blocks, the plurality of indicating blocks being controlled by the displaying control module.

9. The monitoring method of claim 8, comprising numbering each of the plurality of testing locations according to the location information by the testing information collection module.

10. The monitoring method of claim 9, further comprising numbering each of the plurality of indicating blocks by the displaying control module, and numbering a first indicating block of the plurality of indicating blocks same as a first testing location of the plurality of testing locations are same, wherein a relative location of the first testing location relative to the plurality of the testing locations is same as a relative location of the first indicating block relative to the plurality of indicating

11. The monitoring method of claim 8, wherein the testing information comprises states of pre-tested, states of under-tested, states of completed-tested, and states of test-failed.

12. The monitoring method of claim 8, comprising displaying the plurality of indicating blocks with different colors to indicate different testing states.

13. The monitoring method of claim 8, comprising displaying the plurality of indicating blocks on the displaying apparatus in an arrangement same as an arrangement of the plurality of testing locations on a testing apparatus.

14. The monitoring method of claim 13, further comprising indicating testing states of the tested product in a testing location of the plurality of testing locations on an indicating block of the plurality of indicating blocks indicates, wherein a relative location of the testing location relative to the plurality of testing locations is same as a relative location of the indicating block relative to the plurality of indicating blocks.
